(19) United States
(12) Patent Application Publication
(10) Pub. No.: US 2006/0010663 A1
(43) Pub. Date: Jan. 19, 2006

(54) Absorbent sleeve to enclose a limb and absorb seepage from a cadaver

(76) Inventor: Andrew Szypka, Curtice, OH (US)

Correspondence Address: PURDUE LAW OFFICES;2735 N. HOLLAND-SYLVANIA ROAD, SUITE B-2, TOLDEO, OH, 43615, US

(21) Appl. No.: 11/183,400

(22) Filed: Jul. 18, 2005

Related U.S. Application Data
(60) Provisional application No. 60/588,586, filed on Jul. 17, 2004.

(51) Int. Cl. A61G 1/00

(52) U.S. Cl. 27/28

(57) ABSTRACT

A sleeve to enclose and absorb seepage from a limb of a cadaver caused by trauma or the removal of such items as bones, tissue for grafting or the like, is disclosed. The sleeve is composed of a tube of a water impervious cover sheet, an absorbent layer which includes a superabsorbent material, preferably in a quantity sufficient to absorb at least 100 grams of 0.9% saline solution, and a layer of hydrophilic fibers, preferably in a quantity sufficient to absorb at least 25 grams of 0.9% saline solution. The water impervious sleeve, the absorbent layer and the hydrophilic fibers are adhered to one another to form a laminate. A resilient member operable to prevent leakage by urging an end of the tube against the limb of the cadaver is also disclosed, as is an extension of the tube to form a closed foot-like projection to prevent such leakage

### BACKGROUND OF THE INVENTION

(1) Field of the Invention

The present invention relates generally to articles of manufacture that are useful to enclose, for example, during transportation to a funeral home, seepage from limbs, specifically legs and arms, of cadavers. Such seepage occurs as a consequence of trauma or of the removal of bones, tissue and the like for donation. Tissue banks frequently remove bones and tissue from cadavers, particularly from the arms and legs, before the cadavers are shipped to funeral homes. As a consequence of trauma or of the removal of bones, tissue or both, the cadavers are subject to leakage of body fluids, which must be contained.

(2) Description of Related Art Including Information Disclosed Under 37 CFR 1.97 and 37 CFR 1.98

Several US patents and one published US patent application were found by a search for relevant prior art. The patents and the application found are identified below, followed by a brief statement concerning what each discloses:

U.S. Pat. No. 4,790,051, Dec. 13, 1988: a body bag with an outer envelope 10 and an inner liner 11, “constructed of strong, flexible, waterproof, odorproof material such as vinyl.” (column 4, lines 58-59)

U.S. Pat. No. 4,780,940, Nov. 1, 1988: a viewing pouch for a corpse, having a bottom panel, side panels and a top panel preferably formed of white vinyl and and a viewing window of clear vinyl. Heat sealing can be used to prevent leakage.

U.S. Pat. No. 5,335,372, Aug. 9, 1994: An article of clothing is disclosed. The article has an outer layer formed of a tightly woven hydrophobic fabric which forms a liquid barrier and a micro-organism barrier, an inner layer which comprises a material which likewise forms a liquid barrier and a microorganism barrier and is preferably hydrophobic and an intermediate layer which separates the outer layer and the inner layer, in at least at one critical portion of the article, and prevents direct contact of these layers.

U.S. Pat. No. 5,341,548, Aug. 30, 1994: A burial/cremation case for animals incorporating various features of the present invention is illustrated generally at 10 in the figures. The burial/cremation case 10 is designed for transporting, burying, or cremating deceased animals. Moreover, in the preferred embodiment the burial/cremation case 10 is designed to provide an absorbent layer 40 of material for absorbing fluids which drain from the animal 52, thereby preventing the fluids from leaking out of the burial/cremation case 10 and onto other surfaces. The burial/cremation case 10 of the subject patent is constructed such that the animal 52 may be buried or cremated therein.

U.S. Pat. No. 5,063,919, Nov. 12, 1991: discloses a water proof member which protects casts and the like from water damage.

U.S. Pat. No. 5,659,933, Aug. 26, 1997 (abstract) Containers are described for retention of human or animal remains for extended periods. The bags are constructed of laminated materials and sealed, which prevents the escape of noxious or odorous decomposition gases or harmful decomposition fluids into the ambient surroundings. The invention also provides for infusion or extraction of gases to retard the decomposition of the contained remains. The container is constructed of flexible multilayer laminated walls forming an interior chamber for accommodation of remains, and after the remains are emplaced the container's opening is sealed. The multilayer laminate includes at least two layers of polymeric sheet material with a metal foil layer between them, although use of more complex polymer/metal laminates is also described. The polymeric layer materials include polyolefin, nylon or polyvinyl sheet materials and the metal foils are normally aluminum foil. The containers may be furnished flat to the end user and joined in series coiled into large rolls from which the user merely cuts off desired lengths as needed. The roll structure and sealing method may also be used with other types of containment bags.

U.S. Pat. No. 5,715,583, Feb. 10, 1998: The subject invention is directed to an apparatus and method for preserving cadavers. The apparatus is preferably comprised of a container that receives a cadaver, which cadaver has first been placed into a multi-layered plastic bag of the type used in the vacuum-packing industry. The container has the ability to be sealed in a substantially air-tight manner. Located on or coupled to the container is a gas evacuation apparatus, which evacuates substantially all of the gases within the container. The cadaver is then sealed using a sealing apparatus located within the cadaver. The cadaver, in the sealed bag, may then be removed.

U.S. Pat. No. 5,734,992, Apr. 7, 1998: In overview, the subject invention provides a protective article comprising a glove-like component and a component that extends protective coverage to well above the wrist and distal forearm typically to the proximal portion of the upper arm. Protective articles in accordance with the invention afford greater protection to both patients and health care workers as well as the other personnel for whom fluid and pathogen protection is indicated. The invention maintains all the advantages of previously known form-fitted molded health care gloves, i.e., gloves designed for use in sterile medical contexts (to prevent contamination of a sterile field on a patient, and to protect the wearer from fluids and infectious agents), and gloves used in non-sterile settings to prevent infection of the glove wearer.

U.S. Pat. No. 5,761,746, Jun. 9, 1998: A sleeve for keeping arms, legs, hands or feet dry while washing, bathing and/or showering of upper and lower section, with the lower section being composed of a waterproof material stretchable in both longitudinal and latitudinal planes, and with the upper section being composed of a waterproof material exhibiting a substantial adherence characteristic, and including an elastic band for sealing-off the upper section when in use.

U.S. Pat. No. 6,047,403, Apr. 11, 2000: A decorative cast covering for a full leg cast, comprising an elongated, generally cylindrical sleeve having an upper end and a lower end; and a first elastomeric band fixed to the cast covering adjacent the lower end. In this way, the lower end can be securely fastened by the elastomeric band to the bottom of the leg cast. The decorative cast covering further comprises a pocket secured along the generally cylindrical sleeve.

U.S. Pat. No. 6,126,621, Oct. 3, 2000: A cast covering apparatus comprising a flexible cover member having a first closed end and a second end opposite the first end and having an opening into an interior of the cover member, and an absorbent liner positioned within the interior of the cover member. The cover member is not disclosed as being water proof.

U.S. Pat. No. 6,276,264, Aug. 21, 2001: The subject invention relates to a protective sleeve for a chronically-implanted intravenous (IV) site. The sleeve is made of a prophylactic waterproof material, and is normally worn by a person while showering to prevent moisture from invading the IV site. The sleeve in one embodiment has two elastomeric beads which form a watertight seal between a person's arm and the beads, and the sleeve billows in its mid-section so that it does not snag the catheter. The sleeve in another embodiment has a binding at one end and at least a binding at the other end integrally formed in the sleeve or in another embodiment a plurality of indentations axially spaced on a tapered portion of the sleeve.

Published application No. US 2001/0041853 (Nov. 15, 2001): “[0011] The present invention relates to a set of cast covers configured to protect a user's leg, arm, torso or head. Preferably, the covers are fabricated with a latex rubber or nitrile material whereby the covers are durable, reusable and water impermeable.”

In addition, super absorbent polymers have been used widely in diapers for infants and in incontinence products; such use is discussed in U.S. Pat. No. 5,637,106, quoted below (column 1, line 26 through column 2, line 11):

“There has been a great deal of recent development in the field of personal absorbent products ranging from diapers for infants to adult briefs for people with urinary incontinence. One major area of development has been broadly in the field of super absorbent polymers, such as starches, acrylics modified cellulose, gums and the like. In some respects, the super absorbent polymers are far superior to cellulose fluff and other conventional absorbent media used in personal absorbent products. For example, the polymers, on a weight basis, have an absorption capacity which is far greater than fluff. In addition, super absorbent polymers retain absorbed liquid, even under pressure, far better than fluff which is subject to ‘squeeze-out’ where absorbed liquid is released from fluff when it is subjected to pressure.

“There are some drawbacks, however, to super absorbent polymers as components of personal absorbent products. Generally, super absorbent polymers are inferior to fluff in terms of rate of absorption of liquid. Another drawback of super absorbent polymers is their susceptibility to what is referred to as “gel-blocking” where a layer containing super absorbent polymer is wetted, the polymer absorbs the liquid and the gelled polymer, which has expanded to many times its dry size, blocks additional liquid from entering the layer.

“Super absorbent polymers, because they are finely powdered, present manufacturing difficulties in terms of satisfactorily incorporating into absorbent products.

“Super absorbent polymers have been incorporated into absorbent products in a variety of ways. In some cases, super absorbent polymer is sprinkled into a fluff layer or deposited between two fluff layers, as disclosed in U.S. Pat. No. 4,381,782, but these approaches are plagued by problems arising from the migration of the powder from the place it is deposited. Another approach entails the use of tissue with super absorbent polymer powder fixed to it. Such tissue, also known as laminate, has been used in absorbent products alone and in combination with conventional fluff.

“Examples of the use of laminate alone are shown in U.S. Pat. No. 4,568,341. This patent discloses a special laminate structure including undulations and small hinge and flap members formed in the laminate. This laminate structure compensates for the relatively slow absorbency rate of the super absorbent polymer in the laminate.

“Composite absorbent products including one or more layers of laminate and one or more layers of fluff are disclosed in U.S. Pat. Nos. 3,888,256, 4,333,465, 4,411,660, 4,592,751, 4,622,036, 4,643,726 and 4,699,619.

“U.S. Pat. No. 4,055,180 [Oct. 25, 1977] discloses an absorbent article including super absorbent polymer powder disposed in pockets formed in an absorbent pad.

“A product distributed under the trademark Slimline comprises a backing sheet, a facing sheet, a layer of laminate adjacent to the facing sheet and a layer of fluff between the laminate and the backing sheet.”

### BRIEF SUMMARY OF THE INVENTION

The present invention is a highly absorbent sleeve to cover regions of a limb from which leakage of a fluid from a cadaver occurs as a consequence of trauma or of the removal of a bone, tissue or the like. The sleeve has an overall shape which enables it to be slipped over the limb from which leakage occurs, and has an outer layer which is impervious to liquids, and two inner layers, one of which is composed of a non-woven hydrophilic sheet, and the other of which is a layer which comprises particles of a super absorbent polymer, which can be adhered to a tissue or can be adhered directly to the hydrophilic sheet. In a preferred embodiment, a laminate composed of two tissue layers with particles of a super absorbent polymer between the tissue layers constitutes the layer comprising particles of a super absorbent polymer.

It is an object of the present invention to provide a highly absorbent sleeve to cover regions of a limb from which leakage of a fluid from a cadaver occurs as a consequence of trauma or of the removal of a bone, tissue or the like.

It is another object of the invention to provide such a sleeve with a liquid impervious backing layer.

It is a further object of the invention to provide such a sleeve that outperforms the prior art sleeves in terms of absorbent capacity.

These and other objects and advantages of the present invention will be fully appreciated by those skilled in the art upon reviewing the disclosures herein.

### BRIEF DESCRIPTION OF THE SEVERAL VIEWS OF THE DRAWING

FIG. 1 is a plan view of a highly absorbent sleeve for a leg of a cadaver.

FIG. 2 is a view of a portion, which is indicated by the line 2-2 in FIG. 1, of the side of the highly absorbent sleeve.

FIG. 3 is a cross-sectional view taken along the line 3-3 of FIG. 2

FIG. 4 is a plan view of a highly absorbent sleeve for a portion of an arm of a cadaver.

### DETAILED DESCRIPTION OF THE PREFERRED EMBODIMENTS

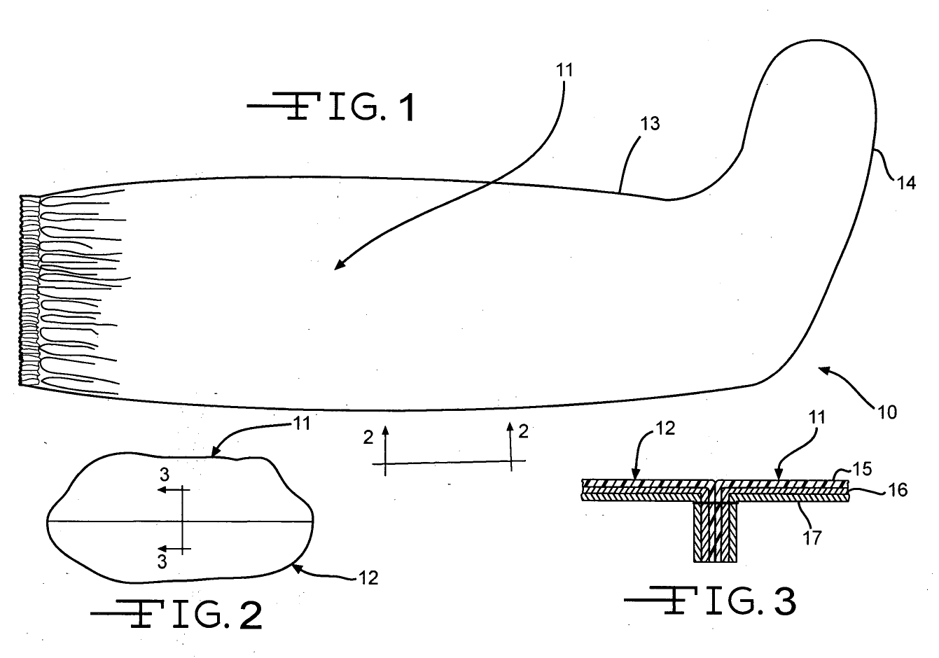

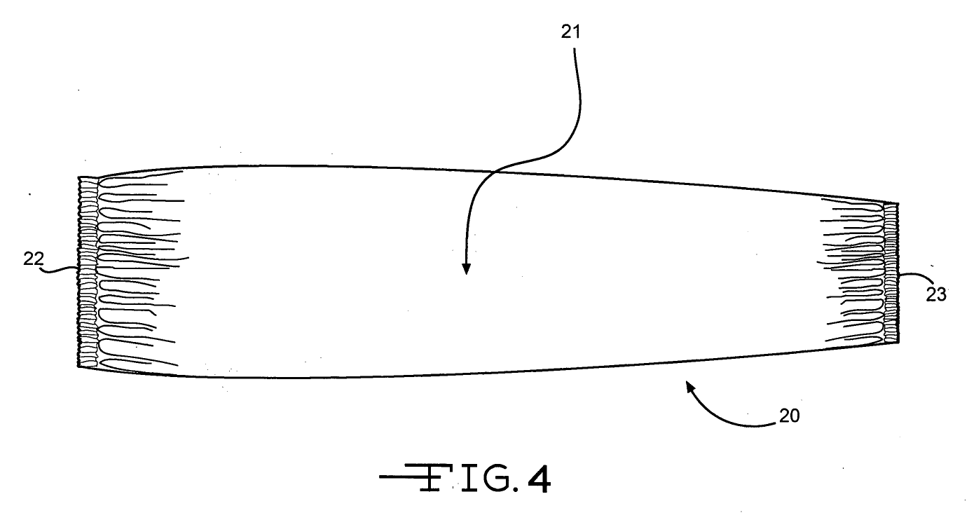

Referring to FIG. 1, an absorbent sleeve according to the present invention is indicated generally at 10. The sleeve 10, which is for a leg of a cadaver, is composed of upper and lower segments 11 and 12 (see FIGS. 2 and 3), which are joined as shown in FIG. 3 to form the sleeve 10 with a generally tubular upper portion 13 and a foot portion 14 (FIG. 1).

The sleeve 10 (see FIG. 3) has a water impervious outer sheet 15 and a laminate composed of two tissue layers 16 and 17 with a superabsorbent polymer between the tissue layers. Such a laminate is commercially available from Gelok International under the designation 7040 S-S, or can be produced as described in U.S. Pat. No. 5,637,106 (see FIGS. 7 and 8). A pressure sensitive adhesive is used to adhere the laminate to the water impervious outer sheet 15, which can be one mil polyethylene sheeting To produce the sleeve 10, two parts are cut from the assembly of the polyethylene sheet with-the laminate, one having the shape shown in FIG. 1 when the outer sheet is up, and one having that shape when the laminate layer is up, and each extending about one-fourth inch beyond the desired perimeters of the tubular portion 13 and of the foot portion 14. The edges of the sleeve parts are then mated as shown in FIG. 3, and the adjacent portions of the water impervious sheets are adhered to one another, for example, with a hot melt type adhesive. An elastic band 18 is then sewed to the open end of the sleeve 10.

It has been found that a sleeve 10 having an overall length of 38 and one half inches at the juncture of the upper and lower segments is capable of absorbing 1800 grams of 1% saline by a standard absorbency test.

Referring to FIG. 4, a sleeve according to the instant invention for an arm of a cadaver is indicated generally at 20. The sleeve 20 is composed of upper and lower segments, only the upper one, designated 21, being shown. The segments are produced and joined as described above with reference to FIGS. 1-3, and elastic bands 22 and 23 are sewed to the open ends of the sleeve.

It has been found that a sleeve 20 having an overall length of 23 and one half inches at the juncture of the upper and lower segments is capable of absorbing 900 grams of 1% saline by the standard absorbency test.

It will be appreciated that the foregoing detailed description is made to comply with the requirement that applicants disclose the best mode known to them for practicing the invention. It will also be appreciated, however, that the invention described above is susceptible of modifications and changes without departing from the spirit and scope thereof as defined in the appended claims.

1. A sleeve to enclose and absorb seepage from a portion of a limb of a cadaver caused by trauma or the removal of such items as bones and tissue for grafting, said cover comprising a tube of a water impervious cover sheet, an absorbent layer comprising a superabsorbent material, and a layer of hydrophilic fibers, said water impervious cover sheet, said absorbent layer and said hydrophilic fibers being adhered to one, another to form a laminate, and means operable, when said cover is on a limb of a cadaver, to prevent leakage of a body fluid from inside said tube.

2. A sleeve as claimed in claim 1 in which the superabsorbent material is present in a quantity sufficient to absorb at least 100 grams of 0.9% saline solution

3. A sleeve as claimed in claim 1 in which the hydrophilic fibers are present in a quantity sufficient to absorb at least 25 grams of 0.9% saline solution:

4. A sleeve as claimed in claim 1 wherein said means operable to prevent leakage of a body fluid from inside one end of said tube is a resilient member operable to urge an end of said tube against the limb of the cadaver.

5. A sleeve as claimed in claim 4 wherein said means operable to prevent leakage of a body fluid from inside a second end of said tube is a resilient member operable to urge the second end of said tube against the limb of the cadaver.

6. A sleeve as claimed in claim 5 wherein said means operable to prevent leakage of a body fluid from inside a second end of said tube is an integral, closed extension of the laminate composed of said water impervious cover sheet, said absorbent layer and said hydrophilic fibers.
